(19) United States
(12) Patent Application Publication
(10) Pub. No.: US 2012/0173620 A1
(43) Pub. Date: Jul. 5, 2012

(54) CREATION AND MANAGEMENT OF RESILIENT WIRELESS GROUPS

(75) Inventors: Vladimir Holostov, Redmond, WA (US); Shai Guday, Redmond, WA (US); Amer Hassan, Kirkland, WA (US)

(73) Assignee: MICROSOFT CORPORATION, Redmond, WA (US)

(21) Appl. No.: 12/981,022

(22) Filed: Dec. 29, 2010

(51) Int. Cl. G06F 15/16

(52) U.S. Cl. 709/204

(57) ABSTRACT

A method and system are disclosed for providing a temporary peer-to-peer network including a group owner, and one or more deputies able to step into the role of group owner to continue the group session in the event the prior group owner cedes ownership. Each device in the group may include a layered communications protocol having a group maintenance layer between the network layer and the physical layer. The group maintenance layer may be responsible for dictating when and under what conditions a deputy device becomes the group owner so that group membership and activities may move forward without loss of continuity.

### BACKGROUND

Devices in a multinode peer-to-peer network can connect in a way that allows users to share, print, synchronize and display content more easily than in a centralized client-server model. In a peer-to-peer (P2P) network, each device in the network can serve as the client and/or server, and no centralized architecture is needed. Devices in a P2P network often form into groups of devices ranging from two to a topology of a few hundred. When the group is formed, the initiating device may assume the role of group owner, acting as the hub through which communications between devices are routed. The group owner may also perform many other centralized control functions, such as admitting new devices into the group, and terminating group sessions.

One drawback to conventional ownership of P2P groups is that it may happen that the group owner drops out of the group or otherwise looses connectivity to the group. In this case, the group then disbands. Members of the group may choose to reestablish the group, but the session information is lost, and the group may or may not have the same composition.

### SUMMARY

Disclosed herein is a system and method forming and maintaining a peer-to-peer network group including a group owner and one or more deputies able to step into the role of group owner to continue the group session in the event the prior group owner cedes ownership. Ownership by the original or subsequent group owner may be ceded by the owner in a variety of ways, including where the owner departs, is unavailable or incurs degradation in the owners capabilities to provide resources to the group.

Upon group formation, and periodically thereafter, the capabilities of each device to provide resources to the group are evaluated to arrive at an ownership metric for each device. Upon group formation, the initiating device may be established as the group owner, or the initial group owner may be established by negotiation between the devices. Thereafter, group ownership may switch to the device having the highest ownership metric. One or more deputies are also determined, based on the next highest capability to provide resources to the group. In embodiments, there may be a single deputy, or a hierarchy of deputies, ranked in order of each deputy device's ownership metric. Several criteria may be factored into the calculation of the ownership metric for each device, including device processing power, device signal strength, device communication capabilities (how many different communication channels does the device support), longevity of the power supply and user preferences. Other criteria may further be used in calculating the ownership metric. As a group is dynamic, the ownership metric for each device may be recalculated and updated periodically.

In embodiments, each device includes a layered communications protocol, similar to a conventional OSI model, but with the addition of a group maintenance layer between the network layer and the physical layer. When a temporary P2P network group is established, the group maintenance layer of the group owner includes information about the group session. This information may include data regarding a state of an application server run by the group owner for an application used by one or more of the group members. This information may further include the number of members in the group, an identity (IP address) for the members in the group, the ownership metric for each device in the group and an indication of the one or more deputies in the group.

In embodiments, this same information may also be mirrored in the group maintenance layer of each deputy. This same information may also be mirrored in the group maintenance layer of every device in the group in further embodiments. The one or more deputies may also run an application server mirroring the application server in the group owner. In the event the original or a subsequent group owner cedes ownership of the group, the devices in the group reestablish their connection with the next deputy in the hierarchy of ranked deputies. As that deputy has all of the information for the group, as well as a mirror copy of the application server, the deputy may step into the role of group owner. All logical connections are maintained and group membership and activities may move forward without loss of continuity.

In one example, the present technology relates to a method of forming a peer-to-peer network group to interact in a group session, comprising: (a) negotiating among the group members to establish a group owner, the group owner containing information regarding the group session; and (b) determining one or more deputies from among the group members other than the group owner, a deputy of the one or more deputies having a copy of the information contained in the group owner, and the deputy capable of assuming the role of group owner to continue the group in the event the group owner cedes group ownership.

In another example, the present technology relates to a computer-readable storage medium for programming a processor to perform a method of providing a peer-to-peer network group to interact in a group session, comprising: (a) negotiating among the group members to establish a group owner, the group owner running an application server for an application used by the group; (b) determining one or more deputies from among the group members other than the group owner, a deputy of the one or more deputies running an application server for the same application and periodically synchronized to the application server run by the group owner; and (c) continuing the session in the event the group owner cedes group ownership by replacing the group owner with the deputy of the one or more deputies, the deputy becoming the new group owner.

In a further example, the present technology relates to a system providing a peer-to-peer network group to interact in a group session, comprising: a plurality of devices forming the network group, the plurality of devices including: an original group owner, the original group owner established based on a determination that the original group owner is best able to provide resources to the group, and a deputy, the deputy established based on a determination that the deputy is best able to provide resources to the group after the original group owner; and a layered communication model in each of the plurality of devices, the layered communication model including a group maintenance layer, the group maintenance layer dictating under what conditions the deputy device replaces the original group owner as a new group owner so that group membership and activities may move forward without loss of continuity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic representation of a P2P network topology according to embodiments of the present technology.

FIG. 2 is a flowchart for forming a P2P group, and establishing a group owner and a hierarchy of deputies.

FIG. 3 is a flowchart showing further detail of establishing a group owner and a hierarchy of deputies as shown in step 210 of FIG. 3.

FIG. 4 is a layered communications protocol for each device in the group including a group manager layer according to embodiments of the present technology.

FIG. 5 is a flowchart showing establishment of a new group owner in the event a prior group owner drops out.

FIG. 6 is a flowchart showing substitution of a new group owner for an old group owner when the ownership metric for the new group owner exceeds that of the old group owner.

FIG. 7 is a flowchart for substitution of a new group owner due to a change in a communication channel used by the group.

FIGS. 8 and 9 are schematic representations of a P2P network topology where a group owner drops out and is replaced by a new group owner.

FIG. 10 is a schematic representation of a network topology showing a new group owner as a result of a change in the location of a group member or a change in the communication channel used.

FIG. 11 is a block diagram of a sample group computing device on which embodiments of the present system may be implemented.

### DETAILED DESCRIPTION

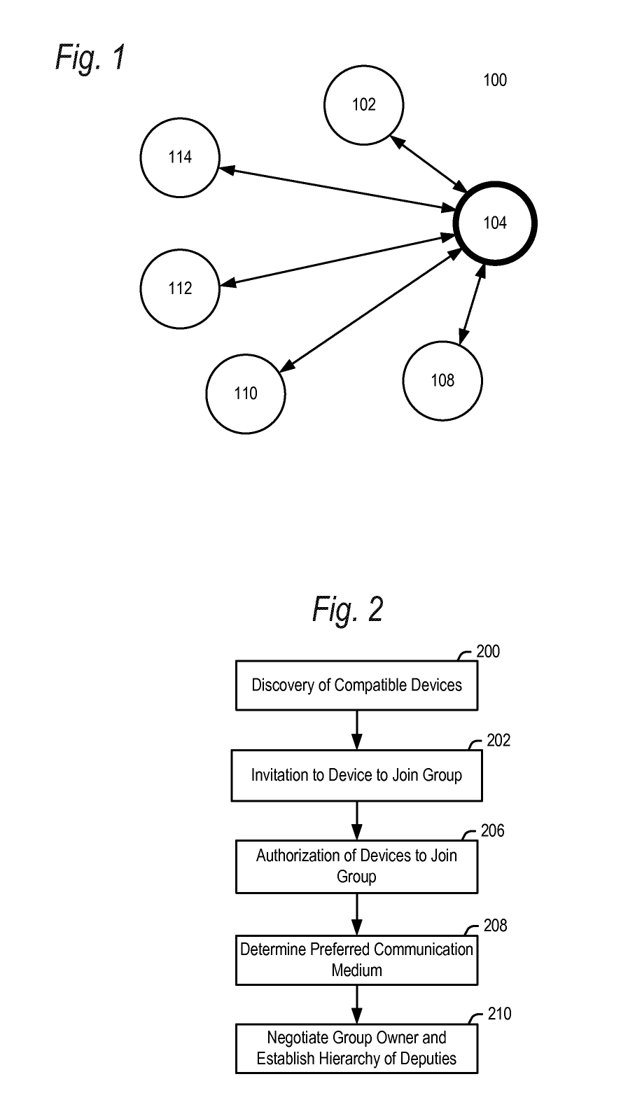

The present system will now be described in reference to FIGS. 1 through 11 which in general relate to a method and system for providing a temporary P2P network including a group owner, and one or more deputies able to step into the role of group owner to continue the group session in the event the prior group owner cedes ownership. The establishment of the group owner and deputies is based on the capabilities of each device to provide resources to the group. The capabilities of each device may be evaluated to arrive at an ownership metric for each device. Upon group formation, the device having the highest ownership metric is established as the group owner. One or more deputies are also determined, based on the next highest ownership metric.

In embodiments, each device includes a layered communications protocol, similar to a conventional OSI model, but with the addition of a group maintenance layer between the network layer and the physical layer. When a temporary P2P network group is established, the group owner may run an application server for the group, and the group maintenance layer of the group owner may include information about the group session. In embodiments, the one or more deputies may each run the same application server, and may each include a group maintenance layer with the same information as the group owner. If a group owner cedes ownership of the group, the next highest deputy may step into the role of group owner and devices in the group may reestablish their connection with the new group owner. All logical connections are maintained and group membership and activities may move forward without loss of continuity.

FIG. 1 illustrates a P2P topology 100 including peer devices 102, 104, 108, 110, 112 and 114. In this example, device 104 is the group owner based on negotiation of ownership metrics as explained below. The group of devices may further include one or more deputies as explained below, and devices which are neither the group owner nor a deputy (such devices are referred to herein as simply group members or members).

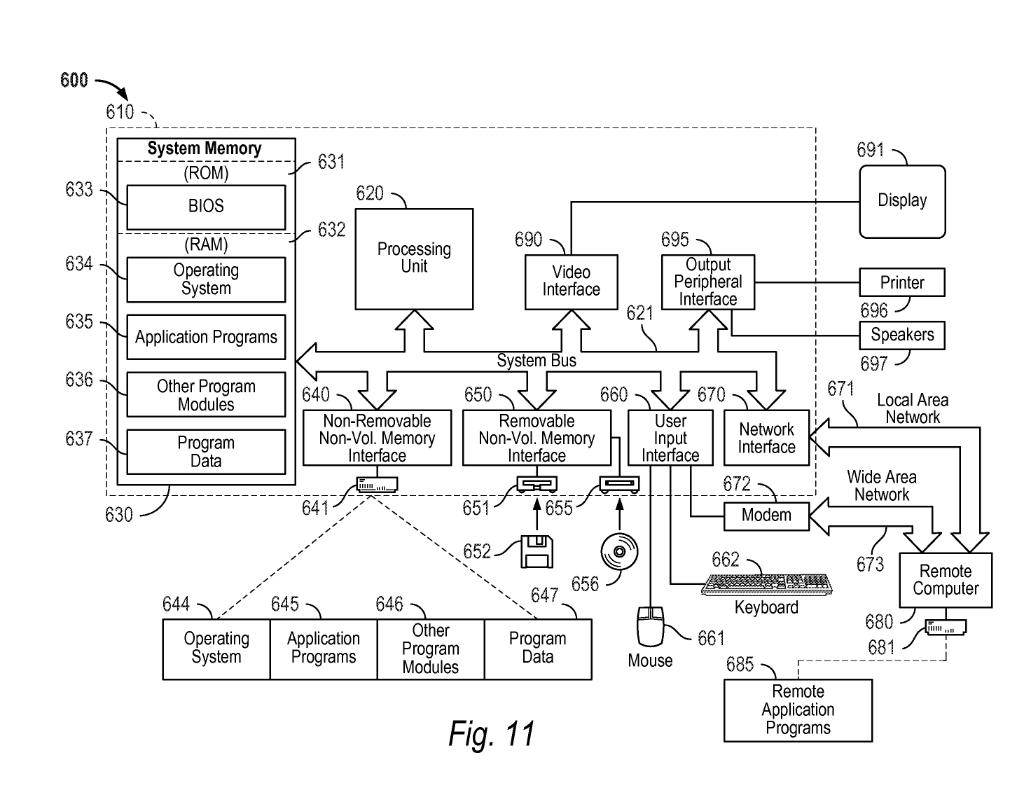

The devices in P2P topology 100 may be any of various electronic and/or computing devices, including but not limited to personal computers, laptops, tablets, mobile phones, cameras, printers, gaming devices, and other devices capable of connecting to each other to directly transfer content and/or share applications. An exemplary embodiment of a computing device is described below with respect to FIG. 11.

Each of the device within P2P network 100 can exchange information with each other, with group owner device 104 acting as the hub. That is, all communications between peers 102, 108, 110, 112, 114 is routed through group owner 104. It is understood that one or more of the peers 102, 108, 110, 112 and 114 may communicate directly with each other in further embodiments. Communication between devices in the P2P network may take place by different communication channels according to any known communication protocol. The different communication channels include for example Blue Tooth or other wireless pico networks, Wi-Fi and other wireless local area networks, and by GPRS (general packet radio service) and other cellular communication technologies. Other communications networks are contemplated.

FIG. 2 is a flowchart showing the formation of the group of devices in P2P network topology 100. In step 200, a first device (which may or may not eventually turn out to be the group owner) may initiate discovery of one or more additional devices to form a P2P network group. In embodiments, the initiating device may send out a beacon including a request for other compatible devices to join the group. If and when devices respond to the discovery beacon, the initiating device may then send out an invitation for the responding devices to join the group in step 202. The initiating device may become the group owner. As explained below, the initial group owner may alternatively be established through negotiation between devices as to which device has the most capabilities to provide resources to the group. Further details relating to the discovery and inviting of devices to form a P2P group are set forth for example in U.S. patent publication 2010/0271959 to Qi et al., entitled “Discovery Channel and Discovery Beacon for Peer-to-peer Devices in Wireless Communications Network,” published Oct. 28, 2010, which publication is incorporated herein by reference in its entirety.

In step 206, devices are authorized and admitted into the group. In one example, a remote device requesting to join the group may present an access token with identification information which may then be accepted or denied by the device initiating group formation. Details relating to an example of an authorization method for admitting members into a group in a P2P network are disclosed in U.S. patent publication 2005/0044411, to Somin, entitled “Peer-to-Peer Authorization Method,” published Feb. 24, 2005, which publication is incorporated by reference herein in its entirety.

Further information regarding the formation and structure of multinode and peer-to-peer networks may be found generally in U.S. Pat. No. 7,613,812, to Manion et al., entitled, “Peer-to-Peer Identity Management Interfaces and Methods,” issued Nov. 3, 2009; U.S. Pat. No. 7,437,440, to Manion et al., entitled, “Peer-to-Peer Networking Framework Application Programming Interfaces,” issued Oct. 14, 2008; U.S. Pat. No. 6,912,622, to Miller, entitled “Multi-Level Cache Architecture and Cache Management Method for Peer-to-Peer Name Resolution Protocol,” issued Jun. 28, 2005; U.S. Pat. No. 7,493,363, to Huitema et al., entitled, “Peer-to-Peer Group Management and Method for Maintaining Peer-to-Peer Graphs,” issued Feb. 17, 2009. Each of the above identified patents and publications is incorporated by reference herein in its entirety.

In step 208, a preferred communication channel for the group is determined. This may for example be Blue Tooth, Wi-Fi or by mobile communications. A variety of known technologies may be used for selecting the preferred communication channel. As explained below, the preferred communication channel may dynamically change, depending on the group composition and whereabouts of the devices in the group.

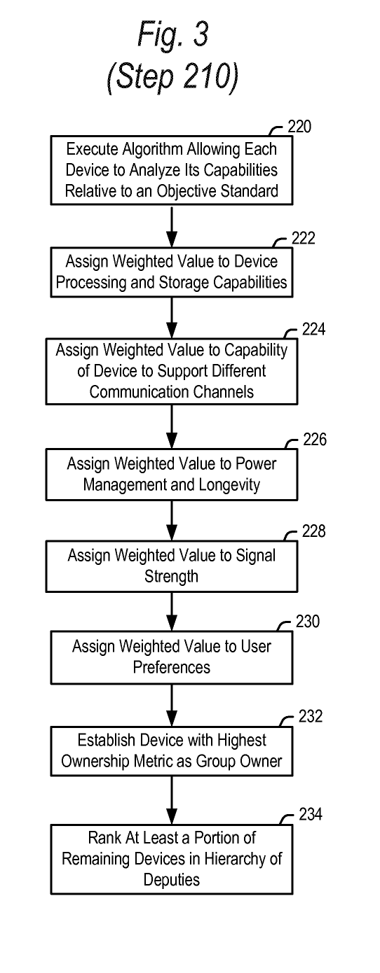

In accordance with the present system, formation of the group may further include step 210 of negotiating the group owner and establishing a hierarchy of deputies. Further details of step 210 are described with reference to the flowchart of FIG. 3. In step 220, an ownership metric calculation algorithm may execute on each device in the group. The ownership metric calculation algorithm allows each device to analyze its own capabilities relative to an objective standard at group formation, and determine an ownership metric value for that device. The algorithm further defines which device parameters are to be factored into the determination of the ownership metric and group owner. It may also be that certain device capabilities are more important than others in determining which device is to be the group owner. The algorithm of step 220 may therefore further define a weighting of each of the parameters to be measured by the algorithm. By this weighting, some device parameters may be weighted more heavily than others in the ultimate determination of the ownership metric for each device.

In steps 222, each device determines its ownership metric based on its capabilities to provide resources to the group. In one example, parameters which may be used as factors in the determination of the ownership metric for each device may include, but are not limited to the following.
Processing and/or storage capabilities of the device may factor into the ownership metric. This may include for example the type and speed of the processor used in the device, and the available memory within the device. (Step 222).
The ability of a device to support different communication channels may factor into the ownership metric. Is the device limited to a single method communication, such as for example Blue Tooth, or does the device have a wide variety of communication options, such as for example Blue Tooth, Wi Fi and cellular communication technology. (Step 224).
Power management and longevity may factor into the ownership metric. Does the device operate off of an internal battery, or is the device plugged into a wall outlet for a constant source of power. The determination of a device's ownership metric may further consider with regard to power management whether the device automatically shuts down after a predetermined period of dormancy. (Step 226).
Signal strength between a given device and each other device over the preferred communication channel may factor into the ownership metric. This parameter for a given device may use the average signal strength between the device and all other devices. Alternatively, the parameter for a given device may simply use the lowest common denominator; i.e., the lowest signal strength between that device and all other devices. If a given device is unable to connect with one or more other devices over the preferred communication channel, that device may be removed as a possible group owner or deputy. Alternatively, communication via another communication channel may be considered. (Step 228).
User preference may factor into the ownership metric. Where one or more users have expressed a preference that a given device is to be used (or not used) as the group owner, that preference may factor into the ownership metric for that device. (Step 230).
   Each device may sum its weighted values for the factors described above in steps 222 through 230 to arrive at the ownership metric. It is understood that other factors may be used in the calculation of the ownership metric for each device.

In embodiments, the ownership metric may range between 0 (never to be the group owner) to a maximum value of 15 (always assume command as the group owner). However, it is understood that the range of 0 to 15 is arbitrarily selected, and could be any normalized range giving the relative capabilities of the different devices to be the group owner.

In step 232, the devices negotiate by exchanging their calculated ownership metrics to determine which device has the highest ownership metric at group formation. That device is established as the group owner. As indicated above, the initial group owner may alternatively be established by which device initiates the group. In such embodiments, the initiating device may remain as the group owner until the group dismisses the initial group owner, for example to replace the initial group owner with the device having the highest ownership metric.

In step 234, at least a portion of the remaining devices are ranked in order of their ownership metric into a hierarchy of deputies. As explained below, it may happen for a number of reasons that a group dismisses the role of the current group owner, at which point group ownership is reassigned to the device having the next highest ownership metric in the group (assuming each of the devices in the group are able to connect to the new group owner at that time). In embodiments, each device after the group owner may be ranked into the hierarchy of deputies. In further embodiments, only a predefined number of the remaining devices may be deputies, for example the next highest one to three devices. It may be more than three in further embodiments.

As discussed above, the group owner may have a variety of responsibilities, including acting as the hub for all communications between group members. The group may executing an application such as for example a game, multimedia application, group conferencing application or other. The group owner may execute the application server used to run the application. All messages and metadata related to group communications and sharing of content may further be stored within the group owner. The group owner may also store the number of devices in the group, and identity (IP address) of all group members, as well as the ownership metric of each device in the group. The group owner may perform other functions and store other group information in further embodiments.

Periodically, the ownership device may send out a beacon including a variety of information. This beacon may be the same discovery beacon discussed above for finding potential new members for the group. In addition, after the formation of the group, this beacon may include the number of devices in the group, the identity of each of the devices in the group, and the ownership metric of itself and the group members. The beacon may include more or less information than this in further embodiments. This information may get sent to each of the devices in the group periodically, such as for example once every 100 milliseconds. The periodicity of the beacon may be more or less frequent than that in further embodiments.

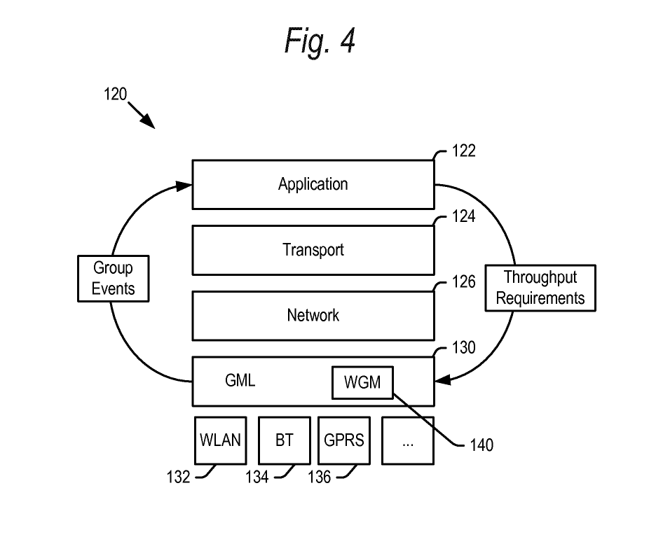

FIG. 4 is a block diagram of a layered communications protocol 120 for a network architecture which may be used in accordance with the present system for communications between devices in the group. Layered model 120 may be similar to a known layered model such as for example an OSI model (open systems interconnection model), modified to further include a group maintenance layer 130 in accordance with the present system. As in a conventional OSI model, model 120 may include an application layer 122, a transport layer 124, and a network layer 126. Similarly, model 120 may include a MAC/physical layer including various communication protocols such as Wi-Fi or wireless LAN layer 132, Blue Tooth or piconet layer 134, GPRS or cellular communications layer 136 and/or other communication protocols. Layered model 120 may include other layers from a known OSI model in embodiments of the present technology.

Group maintenance layer 130 may be interposed between the network layer 126 and the MAC/physical layers 132, 134, 136 of the model 120. In general, the group maintenance layer 130 is responsible for dictating when and under what conditions a deputy device becomes the group owner, and reestablishing connections between the group devices and the new group owner. The group maintenance layer 130 may be resident in every device in the group of P2P network 100.

The group maintenance layer (“GML” 130 in the drawings) keeps a wireless group map (“WGM” 140 in the drawings) which is updated periodically in each device to keep current information regarding the group. This information includes but is not limited to known device names, the communication capabilities of each device, the current communication medium used by the group and the assigned IP addresses, the application capabilities of an application then being run by group members, each device's role in the group (owner, deputy, member), the ownership metric of each device in the group, and individual device capabilities discussed above such as processing power, signal strength and battery power. In further embodiments, device members that are not the group owner or deputies may receive a subset of this information, including at least who the group owner is and who the ranked deputies are.

The wireless group map 140 is updated each time a member joins or departs the group, or a change in any ownership metric in a device occurs (as explained below). The wireless group map 140 may alternatively update once every present time period. The wireless group map is reassessed after each update. In some cases the update may result in a change in the status of group members, including for example electing a new group owner, a change in which devices are deputies and/or a rearranged order of deputies in the ranked hierarchy.

Wireless group map 140 updates are propagated across the group and group members might be required to take action after receiving such an update. Such actions include for example connecting to a new owner. In particular, all devices receiving notification from the wireless group map of a group owner change automatically reconnect to the next highest ranked deputy (assuming there is an available connection to that deputy). The same will happen if an owner unexpectedly becomes unavailable. The devices will be automatically authenticated upon connecting to the new group owner.

Updates received from the wireless group map may further result in a change in a group member to become a deputy, or for that device's position on the ranked hierarchy of deputies to move up or down. Where a member is appointed to deputy, that new deputy receives all information stored in the wireless group map of the group owner so that the new deputy is ready to assume the role of group owner if called upon to do so.

As indicated above, the group owner may also be running an application server for an application in use by the group. In the event a deputy takes over as group owner, it needs to be able to step into the role of the former group owner in hosting the application. Therefore, when a group member becomes a deputy, it initiates an application server to mirror the application server in the group owner. The deputy may receive real time updates to keep the server on the deputy in sync with the server running on the group owner. For example, where the group is running a multi-player game, the application servers in the deputy devices may receive real time or periodic updates of game state to keep the deputy application servers up to date.

A further action which may be caused by updates from a wireless group map 140 is a change in the communications medium. The group owner may initiate a switch to a different communication channel for selected or all group members. This may happen for example if an application does not require high band width and all devices in the group are equipped with Blue Tooth or other small network components. In this instance, the group owner may send out a notification to the group maintenance layer in each device to switch communications channel to the small network. In another example, a device in a group which leaves W-Fi range may be transitioned to GPRS or other cellular communication.

Within each device (or at least within the group owner and deputies), certain events are propagated by the group maintenance layer 130 to the application level 122 to notify the application about changes requiring attention. Thus, the application server may have awareness of network-level events including election of new group owner or deputies, changes in communication medium and admission or departure of group members. Where a group owner departs, the application may for example opt to suspend all activities until connection with a new group owner is established. Similarly, the application 122 may communicate throughput requirements to the group maintenance layer 130, for example to allow selection of an optimal communication channel.

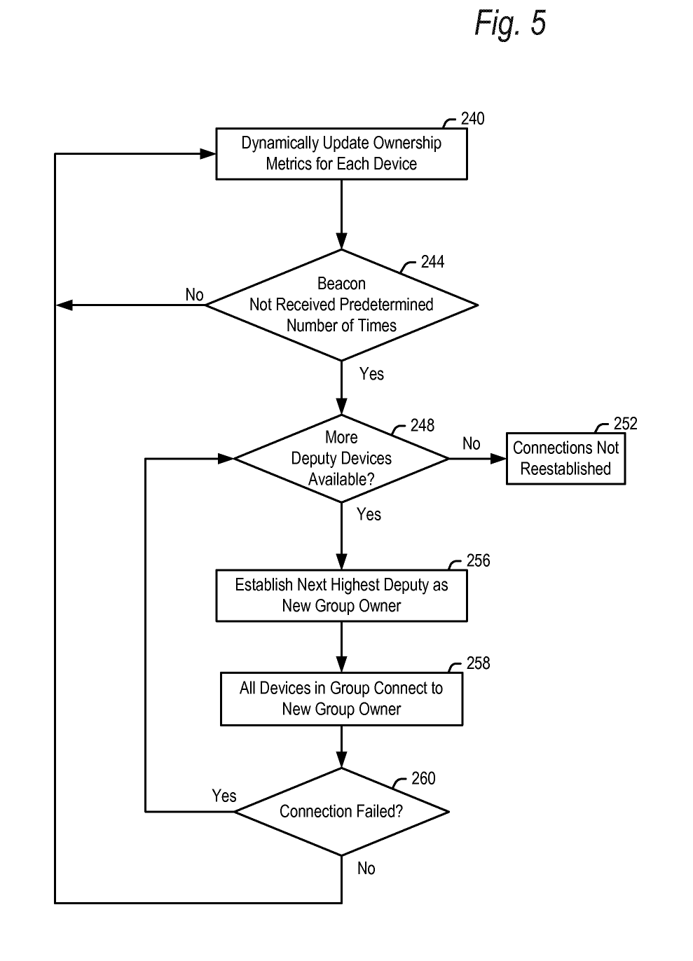

As indicated above, there are a variety of scenarios where a group owner may depart, cede group ownership, or otherwise where the group dismisses the role of the current group owner. In accordance with the present system, instead of this act disbanding the group, the group maintenance layer allows the next highest ranking deputy to move into the role of group owner, and all logical connections are maintained and group membership continues. There are a variety of scenarios where a group owner may cede ownership. A few of those are discussed with respect to the flowcharts of FIGS. 5 through 7.

The flowchart of FIG. 5 describes a so called “disaster recovery” scenario where a group owner cedes ownership by departing or unexpectedly dropping out. One feature of the present technology used in this and other embodiments is that the ownership metrics for each device may be periodically updated to reflect changes that may occur in the devices. In particular, the devices in the group may not be static. Devices may move into and out of range for a given communication channel, and signal strengths and communication channels may change. Moreover, devices operating on batteries or rechargeable power supplies may lose power over time, or go into hibernation mode. As such, the ownership metrics for the group owner, deputies and members of the group may be dynamically updated to reflect these changes (step 240 of FIG. 5). These updates may occur at different time intervals, such as for example once every hundred milliseconds, once every second, once every plurality of seconds, etc. The updated information is written into the wireless group map 140 of the group maintenance layer 130 of each device (or at least the group owner and deputies).

As noted above, the group owner periodically sends out a beacon which is received by the other members in the group. In step 242 of the disaster recovery embodiment of FIG. 5, the deputies and other members in the group determine when that beacon has not been received for a predetermined number of cycles, or a predetermined length of time. For example, if the beacon is not received for three cycles, the flow may move to a step 244, where it is determined if the next highest ranked deputy is available. If the beacon is received as usual, the flow returns to step 240 to update the metrics of each device. Where the frequency of the beacon does not match the frequency of dynamic updates of the ownership metrics, step 242 may return to step 240 once every set number of times through the loop. That is, the dynamic updates of step 240 need not occur with the same frequency of the beacon in step 244.

If it is determined that the beacon has not been received in the last predetermined number of times, it is concluded that the owner has dropped out and ownership is automatically moved to the highest ranked, available deputy. The identity of this device is contained within the updated wireless group map 140 of each device.

In step 248, the group management layer in each device checks whether there is a deputy to which ownership may transfer. It may happen in step 248 that no other devices in the group can be the group owner. This may occur if there were originally only two devices and the group owner dropped out, or it may occur if none of the remaining members can serve as group owners and are not deputies. If that is the case, no connections are reestablished in step 252. On the other hand, if there are more deputies defined in the group, the deputy with the next highest ranked ownership metric is established as the new group owner in step 256. In step 258 all remaining devices in the group connect to the group owner. As noted above, this information is contained in the updated wireless group map of each device.

In step 260, if one or more of the group devices are unable to connect to the new group owner, then that new group owner is not used. The flow returns to step 248 to look for more available deputy devices. If none are found the connections are not reestablished. If one or more are found, the highest ranked is appointed group owner and the devices attempt to connect to the new group owner. Steps 248 through 260 are repeated until a new group owner is established to which all group devices can connect, or it is determined that there are no additional group owners.

Using the steps of FIG. 5, a new group owner may be automatically established whenever a prior group owner unexpectedly drops out. Moreover, the wireless group map of the new group owner contains the information for all logical connections, and the number and IP addresses of all members of the group. Moreover, the application server on the deputy has received updates and should be synchronized with the application server that was running on the departed group owner. As such, the group may be maintained and may continue as before the drop out of the prior owner without loss of continuity.

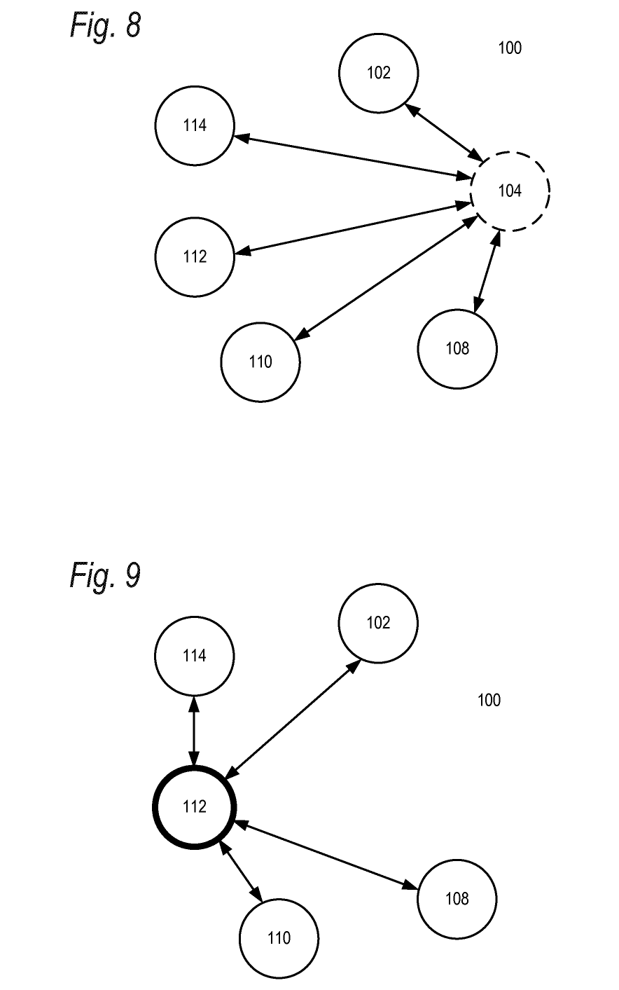

FIGS. 8 and 9 schematically illustrate dynamic replacement of a group owner in the event of a disaster recovery scenario. FIG. 8 shows the P2P network 100 of FIG. 1 where the group owner 104 has dropped out. In this example, device 112 had the highest ownership metric after the missing group owner and was the highest deputy in the deputy hierarchy. As such, after the steps of FIG. 5, device 112 is now the new group owner as shown in FIG. 9, and the remaining devices 102, 108, 110 and 114 connect directly to group owner device 112.

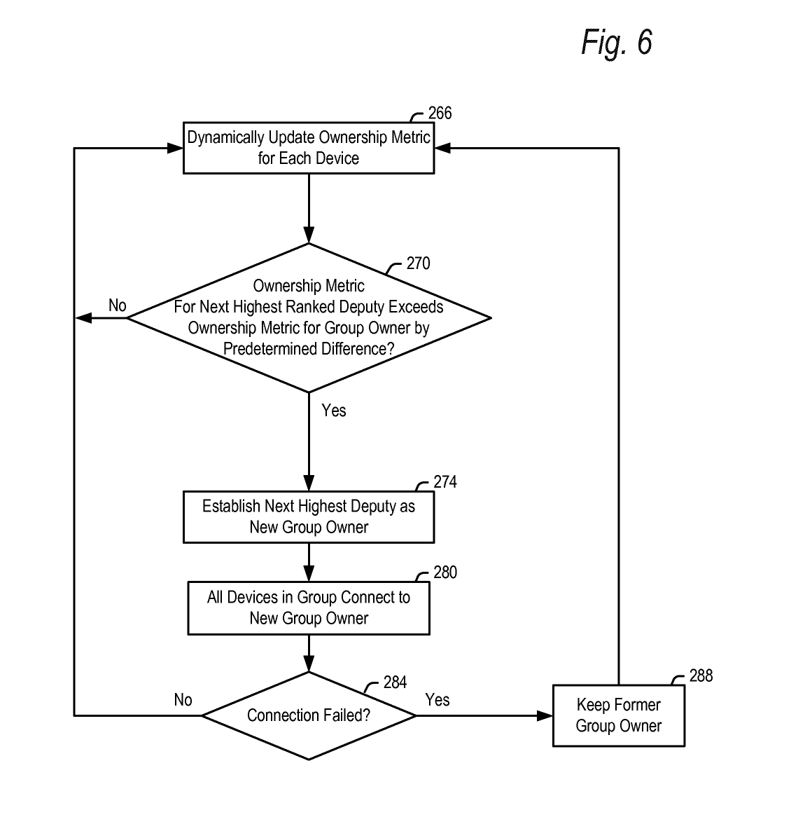

The flowchart of FIG. 6 illustrates another example where group ownership of a group may change. In step 266, the ownership metric for each device may be updated periodically and the result written into the wireless group map of the group owner and deputies as described above. In step 270, the group owner and/or deputies may check whether the ownership metric for the highest ranked deputy exceeds the ownership metric for the group owner by a predetermined difference. In particular, as indicated above, ownership metrics for different devices may change over time. It may happen that the ownership metric for the group owner drops relative to other devices, or the ownership metric for a deputy device increases relative to the group owner.

If the deputy does not exceed the group owner, or does not exceed the group owner by the predetermined margin, the current group owner is maintained. On the other hand, if the next highest ranked deputy exceeds the owner by a predetermined margin, the next highest ranked deputy is established as a new group owner in step 274.

The predetermined difference in step 270 is provided because there is a switching inefficiency cost associated with switching owners. As such, in embodiments, the change does not occur right when a deputy exceeds the current group owner, as this may result in frequent flip-flopping of group ownership, for example when the prior owner's metric again improves. In this embodiment, the prior owner may not depart, and may become a deputy. Thus, in embodiments, ownership changes when the deputy exceeds the current group owner by some predetermined difference. In further embodiments, it is understood that the ownership of the group may change from the current group owner to the deputy any time the ownership metric of the deputy exceeds that of the group owner.

In step 280, all devices in the group connect to the new group owner. In step 284, the system checks whether one or more of the group devices fail to connect to the new group owner. If so, the former group owner is kept in step 288. Otherwise, the new group owner is established. As discussed above, the wireless group map and application server of the new group owner is periodically updated with the latest group information, and is able to step into the role of the former group owner without a loss of continuity.

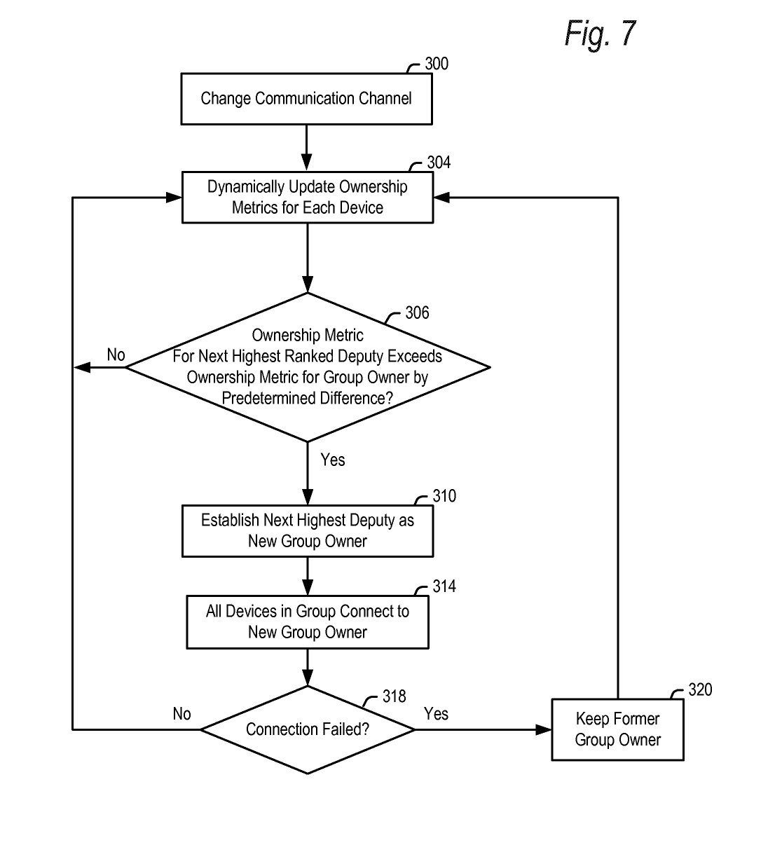

The scenario of FIG. 7 is similar to that of FIG. 6. However, in this embodiment, the change in group ownership results from a change in the communication channel. In particular, for a variety of reasons, the group maintenance layer 130 may switch the communication method used by the physical layer, such as for example changing from Wi-Fi to Blue Tooth or cellular, from Blue Tooth to Wi-Fi or cellular, or from cellular to Wi-Fi or Blue Tooth.

One reason this may happen is that the application being run by the group may be more efficiently or more easily run using a different communication channel. For example, when the current communication channel is Wi-Fi, and the application being run by the group has low bandwidth requirements, the group maintenance layer 130 may determine it is more efficient to run using Blue Tooth communication protocols.

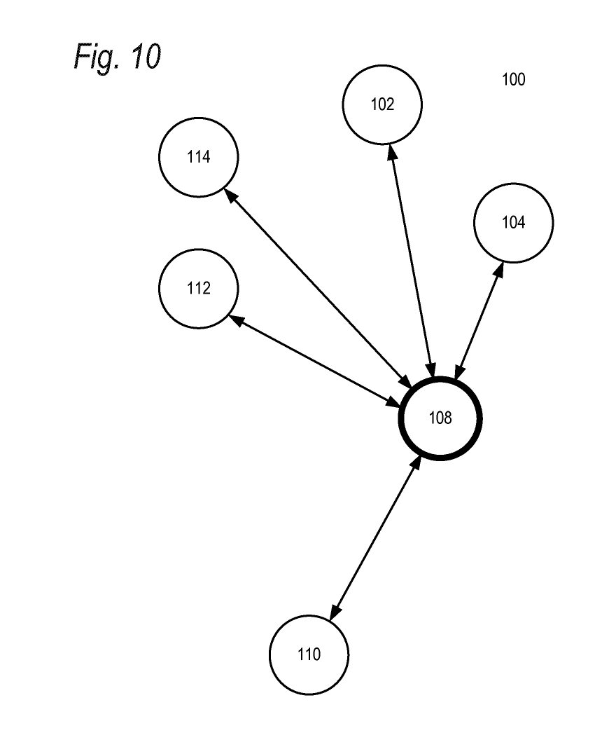

It may also be necessary to change the communication channel where one or more of the devices changes its physical location relative to other group members but wishes to stay connected to the group. This scenario is explained with respect to FIG. 10. FIG. 10 is an illustration of the group 100 similar to FIG. 1. However, in this instance, device 110 has moved away from the group. If, for example, the group is communicating using Blue Tooth communication protocols, device 110 may now be out of range of group owner device 104.

However, it may be determined in the calculation of the ownership metrics for each device that device 108 is within Blue Tooth communication range of device 110, as well as that of the other devices 102, 104, 112 and 114. In such an example, it may be desirable to maintain communications using Blue Tooth. As such, deputy device 108 takes over as the group owner as explained below with respect to FIG. 7. As an alternative, in the above example, it may be that device 110 has moved away from the group so that Blue Tooth communication of the device 110 with the group is no longer possible. It may further be that group owner device 104 is capable of only Blue Tooth communication whereas deputy device 108 is capable of cellular communication. This may be another example in FIG. 10 where group ownership would switch from device 104 to device 108.

Referring now to FIG. 7, the communication channel is changed by the group maintenance layer in step 300 for any of a variety of reasons, some of which have been discussed above. In step 304, the ownership metric for each device may be updated to reflect each devices ability to provide resources to the group using the new communications channel.

Given the possibly revised ownership metrics for the new communications channel, in step 306, the group owner and/or deputies may check whether the ownership metric for the highest ranked deputy exceeds the ownership metric for the group owner by a predetermined difference as discussed above with respect to FIG. 6. If not, the current group owner is maintained.

On the other hand, if the deputy device exceeds the current group owner by the predetermined margin, the deputy is established as the new group owner in step 310, and all devices in the group connect to the new group owner in step 314.

In step 318, the system checks whether one or more of the group devices fail to connect to the new group owner. If so, the former group owner is kept in step 320. Otherwise, the new group owner is established. As discussed above, the wireless group map and application server of the new group owner is periodically updated with the latest group information, and is able to step into the role of the former group owner without a loss of continuity.

FIG. 11 shows an exemplary computing system which may be any of the computing systems mentioned above. FIG. 11 shows a computer 610 including, but not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 11 illustrates operating system 634, application programs 635, other program modules 636, and program data 637.

The computer 610 may also include other removable/non-removable, volatile/nonvolatile computer storage media. By way of example only, FIG. 11 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 11, provide storage of computer readable instructions, data structures, program modules and other data for the computer 610. In FIG. 11, for example, hard disk drive 641 is illustrated as storing operating system 644, application programs 645, other program modules 646, and program data 647. These components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 11. The logical connections depicted in FIG. 11 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 11 illustrates remote application programs 685 as residing on memory device 681. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method of forming a peer-to-peer network group to interact in a group session, comprising:
(a) negotiating among the group members to establish a group owner, the group owner containing information regarding the group session; and
(b) determining one or more deputies from among the group members other than the group owner, a deputy of the one or more deputies having a copy of the information contained in the group owner, and the deputy capable of assuming the role of group owner to continue the group in the event the group dismisses the role of current group owner.

2. The method of claim 1, where the group session information includes data regarding a state of an application server acting as host for an application used by one or more of the group members.

3. The method of claim 1, where the group session information includes data regarding the number of group members and an IP address of the group members.

4. The method of claim 1, wherein said step (b) of the deputy being capable of assuming the role of group owner in the event the group owner cedes group ownership comprises the step of the deputy assuming the role of group owner in the event the group owner departs, becomes unavailable or incurs degradation in metrics used to measure the group owner's capabilities to provide resources for the group.

5. The method of claim 1, further comprising the step of selecting the group owner and one or more deputies in a ranked order based on capabilities of the group owner and one or more deputies to provide resources for the group.

6. The method of claim 5, the capabilities for a device in the group measured by device metrics including at least one of battery power of the device, signal strength of the device, communication capabilities of the device, computing power of the device and user preferences set for the device.

7. The method of claim 1, further comprising the step of communicating the identity of the deputy device to all devices in the group.

8. The method of claim 7, further comprising the step of each device switching their connection to the deputy device upon the deputy device becoming the group owner.

9. The method of claim 1, further comprising the step of switching communication channels from a first communication channel to a second communication channel upon a detected change in an ability of the group owner to communicate with each of the devices in the group via the first communication channel.

10. The method of claim 9, wherein said change from the first communication channel to the second communication channel results in a change in the group owner to the deputy device.

11. A computer-readable storage medium for programming a processor to perform a method of providing a peer-to-peer network group to interact in a group session, comprising:
(a) negotiating among the group members to establish a group owner, the group owner running an application server for an application used by the group;
(b) determining one or more deputies from among the group members other than the group owner, a deputy of the one or more deputies running an application server for the same application and periodically synchronized to the application server run by the group owner; and
(c) continuing the session in the event the group owner cedes group ownership by replacing the group owner with the deputy of the one or more deputies, the deputy becoming the new group owner.

12. The computer-readable medium of claim 11, further comprising the step of the group members switching connection from the original group owner to the new group owner upon the deputy of the one or more deputies becoming the new group owner.

13. The computer-readable medium of claim 12, further comprising the step of continuing the application running in the group by switching control to the application server running on the new group owner.

14. The computer-readable medium of claim 12, further comprising the step of automatically authenticating the group members upon the group members switching connection from the original group owner to the new group owner.

15. The computer-readable medium of claim 11, the group owner and the deputy of the one or more deputies further including data regarding the number of group members and group member identities.

16. The computer-readable medium of claim 11, said step (b) of determining one or more deputies from among the group members comprising the step of determining which devices are best able to provide resources to the group after the group owner.

17. A system providing a peer-to-peer network group to interact in a group session, comprising:
a plurality of devices forming the network group, the plurality of devices including:
an original group owner, the original group owner established based on one of: i) which device initiates the group, and ii) a determination that the original group owner is best able to provide resources to the group, and
a deputy, the deputy established based on a determination that the deputy is best able to provide resources to the group after the original group owner; and
a layered communication model in each of the plurality of devices, the layered communication model including a group maintenance layer, the group maintenance layer dictating under what conditions the deputy device replaces the original group owner as a new group owner so that group membership and activities may move forward without loss of continuity.

18. The system of claim 17, wherein the determination establishing the group owner and the deputy is based on capabilities of the group owner and the deputy is based on metrics including at least one of battery power of the device, signal strength of the device, communication capabilities of the device, computing power of the device and user preferences set for the device.

19. The system of claim 18, wherein the capabilities and identity of the group owner and the deputy are stored in the group maintenance layer of each device in the plurality of devices, the identity of the deputy in the group maintenance layer of the plurality of devices allowing devices of the plurality of devices to connect to the deputy upon the deputy replacing the group owner as the new group owner.

20. The system of claim 17, wherein the deputy runs an application server mirroring an application server on the original group owner, and the group maintenance layer in each device of the plurality of devices is aware to connect to the deputy if the group owner becomes unavailable, the deputy includes information relating to the number and identity of group members.
